(19) United States
(12) Patent Application Publication
(10) Pub. No.: US 2012/0127084 A1
(43) Pub. Date: May 24, 2012

(54) VARIABLE LIGHT DIFFUSION IN INTERACTIVE DISPLAY DEVICE

(75) Inventors: Timothy Large, Bellevue, WA (US); Karlton Powell, Lake Stevens, WA (US); Steven Bathiche, Kirkland, WA (US)

(73) Assignee: MICROSOFT CORPORATION, Redmond, WA (US)

(21) Appl. No.: 12/949,416

(22) Filed: Nov. 18, 2010

(51) Int. Cl. G06F 3/041

(52) U.S. Cl. 345/173

(57) ABSTRACT

Embodiments are disclosed that relate to variable diffusers in interactive display devices. One embodiment provides an interactive display device comprising a display panel configured to display an image on an interactive surface, an image capture device configured to capture an image of the interactive surface, a variable diffuser disposed optically between the display panel and the image capture device, a logic subsystem comprising one or more logic devices, and memory comprising instructions executable by the logic subsystem to operate the display panel, the image capture device, and the variable diffuser.

### BACKGROUND

An interactive display device, such as surface computing device, may be configured to allow a user to interact with the device via a touch-interactive display surface, rather than, or in addition to, peripheral input and output devices such as keyboards, cursor control devices, and monitors. A variety of touch-sensing mechanisms may be used to sense touch in an interactive display device, including but not limited to capacitive, resistive, and optical mechanisms. An optical touch-sensing mechanism may utilize one or more cameras to acquire images of the touch-sensitive surface, thereby allowing the detection of fingers and other objects touching the touch-sensitive surface in such images.

### SUMMARY

Various embodiments are disclosed herein that relate to the use of variable diffusers in interactive display devices. For example, one disclosed embodiment provides an interactive display device comprising a display panel configured to display an image on an interactive surface, an image capture device configured to capture image of the interactive surface, a variable diffuser disposed optically between the display panel and the image capture device, the variable diffuser being switchable between two or more states comprising a less diffusive state and a more diffusive state, a logic subsystem comprising one or more logic devices, and memory comprising instructions executable by the logic subsystems to operate the display panel, the image capture device, and the variable diffuser.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic depiction of an embodiment of an interactive display system comprising a variable diffuser.

FIG. 2 shows a flow diagram depicting an embodiment of a method of operating an interactive display system comprising a variable diffuser.

FIG. 3 shows a timing diagram depicting a non-limiting example implementation of the embodiment of FIG. 2.

FIG. 4 shows a schematic depiction of an embodiment of an interactive display system comprising a variable diffuser and a protective layer.

FIG. 5 shows a schematic depiction of an embodiment of an interactive display system comprising a variable diffuser and a protective layer separated from a front light system by a low index gap.

FIG. 6 shows a schematic diagram of another embodiment of an interactive display system comprising a variable diffuser.

FIG. 7 shows a flow diagram depicting another embodiment of a method of operating an interactive display system comprising a variable diffuser.

FIG. 8 shows a timing diagram depicting a non-limiting example implementation of the embodiment of FIG. 7.

FIG. 9 shows a schematic depiction of another embodiment of an interactive display system comprising a protective layer separated from a front light system by a low index gap.

### DETAILED DESCRIPTION

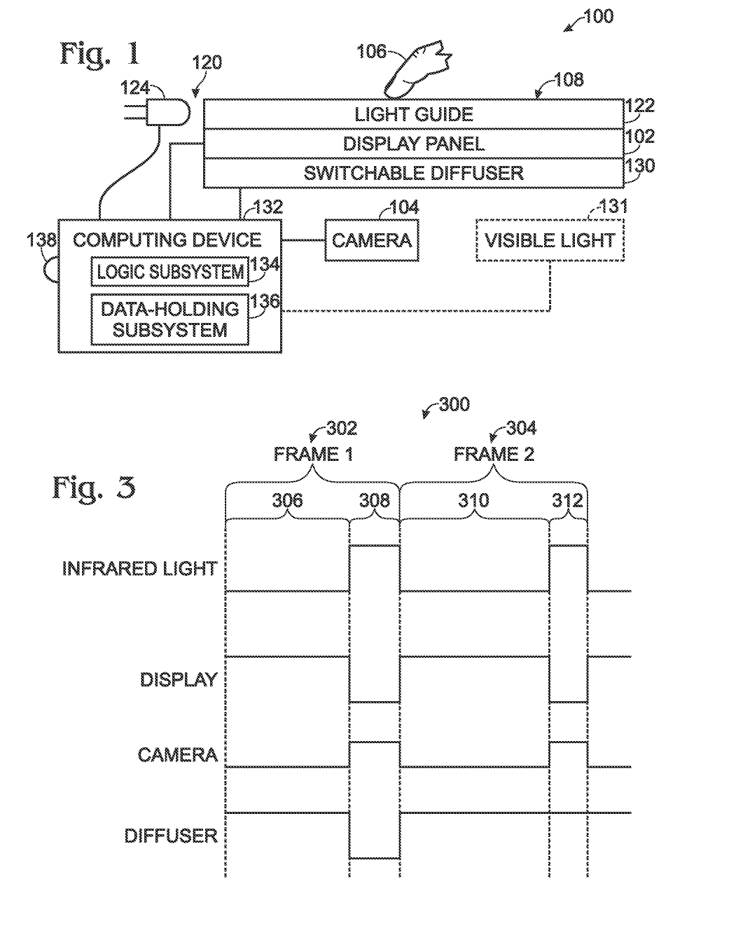

FIG. 1 shows an embodiment of an interactive display device 100 comprising a display panel 102 configured to display an image to a user. The interactive display device 100 also comprises an image capture device, shown as a camera 104, configured to acquire images of an interactive surface 108 to detect a touch input, for example, by a user's finger 106 and/or by other objects on or over the interactive surface 108. As such, where the camera 104 is positioned optically behind the display panel 102 from the perspective of a user, the camera 104 may be configured to detect light of a wavelength that passes through the display panel regardless of a state of the image-producing material of the display panel.

As more specific examples, where the display panel 102 is a liquid crystal display (LCD), the camera may be configured to capture images in the near infrared spectrum, as light in the near infrared spectrum may pass through an LCD panel regardless of the state of the liquid crystal material in each pixel. Further, since an LCD may be equipped with RGB filters, the camera may he configured to capture images in the visible spectrum, by driving the display with content which makes the display transparent for each of the RGB cells within each pixel. In addition, both IR images and color images may be captured by the camera system through varying the configuration of the visible backlight, display content, and the image capturing system over time. Likewise, where the display panel 102 is an organic light-emitting device (OLED), the camera may be configured to detect light from near IR to near UV wavelengths, or a simultaneous combination of wavelengths such as in the case of a color image. It will be understood that the term “interactive surface” may in some embodiments comprise a surface with which a user may interact by touch, postures, gestures, hover, and/or other interactions performed on or over the surface. While the depicted image sensor is located on an opposite side of the display panel as the light guide, it will be understood that the image sensor may be located in any other suitable position. For example, the image sensor may be integrated into the display panel as a sensor-in-pixel (SIP) arrangement in some embodiments.

It also will be understood that the display panel may be any suitable array-based display panel including but not limited to an emissive display such as a transparent OLED or other OLED, and/or a light modulating display such as an LCD panel, an electrowetting display (transparent type), MEMS aperture array, etc. A color electrowetting display may be configured to operate either with “on” pixels or “off” pixels displaying color. Where color is displayed by “on” pixels, a black oil may be used so that an “off” pixel is black & absorbs all light and color filters absorb a portion of white light in “on” pixels to produce color. Where color is displayed by “off” pixels, colored dyes may be used in the electrowetting material such that the “off” state has color. In colored dye electrowetting displays, the display states are levels in between filtered light for display ‘on’/electrode-‘off’ and open, non-filtered light for display ‘on’. In such a panel, dyes for each color may be selected to exhibit IR transmission and visible filtration to allow a vision-based touch detection system to see through such a panel.

With the device of FIG. 1, multiple temporally overlapping touches may be detected and tracked on the interactive surface 108. While the depicted interactive display device 100 utilizes a display panel to display an image to a user, any other suitable display mechanism, including a projection mechanism, may be used. Further, it will be understood that various optics, including but not limited to wedge optics (e.g. an optical wedge placed behind the display panel), lenses, Fresnel lenses, mirrors, and/or filters, may be used to deliver an image to the camera 104.

To aid in detecting objects touching the interactive surface 108, the interactive display device 100 comprises a front lighting system 120 comprising a light guide 122 and an illuminant 124 configured to introduce infrared light into the light guide 122, and also comprises a variable diffuser 130. The light guide 122 may have any suitable configuration. For example, in some embodiments, the light guide 122 helps facilitate touch detection via Frustrated Total Internal Reflection (FTIR). In FTIR systems, the presence of a dielectric material within close proximity (e.g. less than half a wavelength) of the light guide 122 causes light to leak out of the waveguide into the material. Wetting caused, for example, by oils, greases, or pressure applied to very soft materials like silicone rubber, also may cause the same leakage effect. Thus, when a finger or other object touches light guide 122, light leaks out into the finger and is scattered, and some of the scattered light returns through the waveguide to camera 104.

FTIR systems in which the user directly touches the light guide (“naked” FTIR systems), may suffer some drawbacks. For example, light in such systems may be scattered by residual fingerprint oil, smudges due to accidental spills or splatter by users, or poor cleaning. Further, there may be wide variations in signal level from person to person, depending upon skin tone.

Other FTIR systems, which may be referred to as “covered” FTIR systems, include a barrier layer between the skin and the waveguide. In some systems, the barrier layer may serves a secondary function as a projection screen upon which an image is projected from behind.

In yet other embodiments, in order to detect objects not in contact with the surface, the light guide 122 may he made “leaky” by adding a controlled diffusion to one or both of the top and bottom surfaces of the light guide. Thus, even in the absence of a touch, some light escapes from the light guide thereby illuminating objects and allowing the vision system to detect objects that are not in contact with the surface. It will be understood that backlighting systems, in which the illuminant is located behind the display panel relative to the interactive surface, also may he used to illuminate objects for detection.

The variable diffuser 130 is configured to he electronically switchable between two or more states that comprise at least a more diffuse state and a less diffuse state. In some embodiments, the variable diffuser 130 may comprise a diffusivity that is controllable along a continuum between clear and highly diffuse. In such embodiments, the terms “more diffuse” and “less diffuse” may signify any states of the variable diffuser that have a greater and lesser diffusivity relative to one another. In other embodiments, the variable diffuser 130 may have two or more discrete states, and the terms “more diffuse” and “less diffuse” may signify any discrete states having a greater and lesser diffusivity relative to one another. Further, the variable diffuser also may be segmented, such that the diffusivity of different regions of the variable diffuser may be independently controlled, Any suitable material may be used to form the variable diffuser, including but not limited to a Polymer-Dispersed Liquid Crystal (PDLC) material. While shown in FIG. 1 as being positioned behind the display panel from the perspective of a user, it will be understood that, in other embodiments, the variable diffuser may be located on a same side of the display panel as a user, as described below.

The variable diffuser 130 may perform various functions in the interactive display device 100, depending upon the nature of the display panel used. For example, where the display panel 102 is an LCD panel, the variable diffuser may be used in conjunction with a visible light source 131 configured to illuminate the variable diffuser to thereby backlight the LCD panel. In such a configuration, the variable diffuser 130 may be switched to a more diffuse state while an image is displayed by the display panel 102, and to a less diffuse state when an image is being acquired by the camera 104. In such embodiments, the visible light source 131 may be switched off whenever the variable diffuser 130 is in a less diffuse state. Likewise, in embodiments where the display panel 102 is an OLED panel, the variable diffuser may help to hide internal components of the interactive display device 100 when an image is being displayed and when the camera 104 is not integrating an image.

Note that in some embodiments, an IR image may be captured at the same time that the display is displaying an image and the backlight is turned on, by making use of wavelength selective filters, in this case an IR transmissive and visibly opaque filter, as described in more detail below.

The interactive display device 100 further comprises a computing device 132 having a logic subsystem 134, and also having a data-holding subsystem 136 comprising instructions stored thereon that are executable by the logic subsystem 134 to perform the various methods disclosed herein. In particular, the methods and processes described herein may be implemented as a computer application, computer service, computer API, computer library, and/or other computer program product. Computing device 132 is shown in simplified form. It is to be understood that virtually any computer architecture may be used without departing from the scope of this disclosure.

The logic subsystem 134 may include one or more physical logic devices configured to execute one or more instructions. For example, the logic subsystem 134 may he configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem 134 may include one or more processors that are configured to execute software instructions. Additionally or alternatively, the logic subsystem 134 may include one or more hardware or firmware logic machines configured to execute hardware or firmware instructions. Processors of the logic subsystem 134 may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing; configuration.

The data-holding subsystem 136 may include one or more physical, non-transitory, devices configured to hold data and/or instructions executable by the logic subsystem to implement the herein described methods and processes. When such methods and processes are implemented, the state of the data-holding subsystem 136 may be transformed (e.g., to hold different data).

The data-holding subsystem 136 may include removable media and/or built-in devices. The data-holding subsystem 136 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. The data-holding subsystem 136 may include devices with one or more of the following characteristics: volatile, nonvolatile, dynamic, static, read/write, read-only, random access, sequential access, location addressable, tile addressable, and content addressable. In some embodiments, the logic subsystem 134 and the data-holding subsystem 136 may be integrated into one or more common devices, such as an application specific integrated circuit or a system on a chip.

FIG. 1 also shows an aspect of the data-holding subsystem in the form of computer-readable storage media 138, which may be used to store and/or transfer data and/or instructions executable to implement the herein described methods and processes. Computer-readable storage media 138 may take the form of CDs, DVDs, HD-DVDs, Blu-Ray Discs, EEPROMs, and/or floppy disks, among others. Computer-readable storage media 138 is distinguished herein from computer-readable communications media configured to transmit signals between devices.

The term “program” may be used to describe an aspect of computing device 132 that is implemented to perform one or more particular functions. In some cases, such a module, program, or engine may be instantiated via the logic subsystem 134 executing instructions held by the data-holding subsystem 136. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The term “program” is meant to encompass individual or groups of executable files, data files, libraries, drivers, scripts, database records. etc.

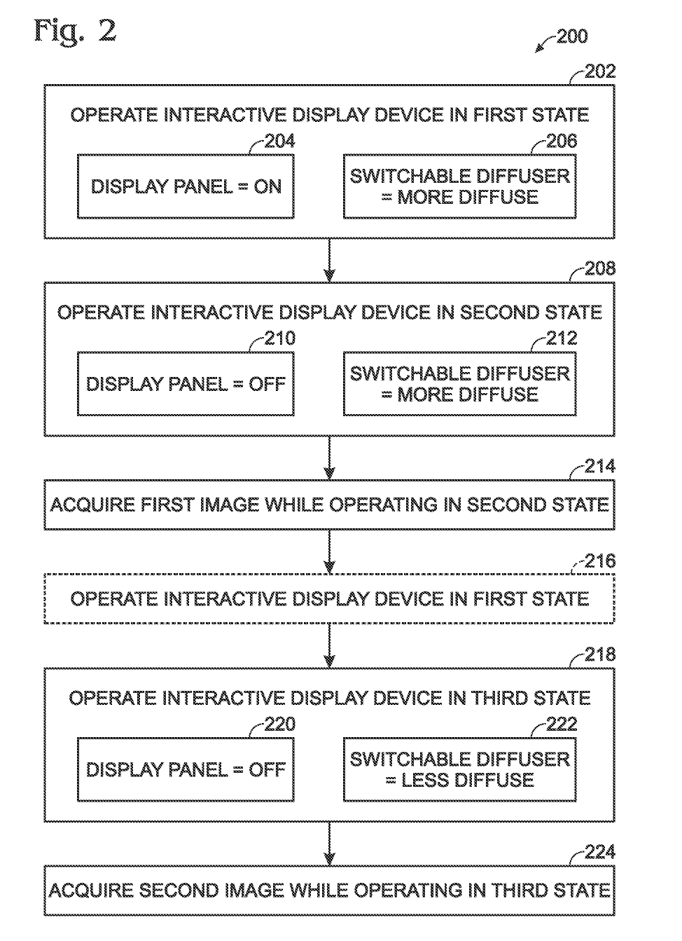

Continuing, in the embodiment of FIG. 1, the variable diffuser is placed optically between the display panel 102 and the camera 104 or other image capture device. FIG. 2 illustrates an embodiment of a method 200 of operating an interactive display device having such a configuration. Method 200 comprises, at 202., operating the interactive display device in a first state in which the display panel is on (“on” indicates that the display panel is displaying an image), as indicated at 204, and the variable diffuser is in a more diffuse state, as indicated at 206. In this state, the variable diffuser may be used as a backlight in embodiments where the display panel is a LCD panel, and may help to block a user's view of internal components of the interactive display system where the display panel is an OLED or LCD panel.

Next, method 200 comprises, at 208, operating the interactive display device in a second state in which the display panel is off (“off” indicates that the display panel is not displaying an image), as indicated at 210, and the variable diffuser is in a less diffuse state. as indicated at 212. While operating the interactive display device in the second state, method 200 further comprises, at 214, acquiring a first image with the image capture device.

Continuing, method 200 may optionally comprise, at 216, again operating the interactive display device in the first state before operating the interactive display device in a third state at 218 or may proceed directly to the third state without operating again in the first state. In the third state, the display panel is in an “off” state, as indicated at 220, and the variable diffuser is in a less diffuse state, as indicated at 222. Method 200 further comprises, while operating the interactive display device in the third state, acquiring a second image with the image capture device, as indicated at 224.

The first and second images may then be used to distinguish objects touching or closer to the interactive surface of the interactive display device from objects located farther away from the interactive surface. For example, objects close to the surface may appear sharply defined in both images, whereas objects off the surface may be sharply defined only in the second image (acquired when the variable diffuser was in the less diffuse state). Further, by comparing the gradient content of the images, proximity of the object may he measured, and touch events determined. For determining touch, in one scenario the first image alone may be used to determine proximity, while in another scenario both the first and second images may be used.

It will be understood that, in some embodiments, images may be captured at a range of variable diffuser states between a fully “off” state and a fully “on” state (e.g. where the variable diffuser is transparent to incident light and where the variable diffuser is completely diffuse to incident light), potentially at any state anywhere in between these two extremes. This may allow the calculation of a distance an object is away from the screen by looking at how “in focus” the objects are, wherein objects farther from the display remain blurry for longer than objects closer to the display as the variable diffuser is changed from more diffuse to less diffuse. By utilizing a sufficient number of images at such intermediate diffusivity states, a three-dimensional image of an object may be constructed as parts of the object come into focus along the z-axis (e.g. normal to the display screen plane) as the diffusivity of the variable diffuser is decreased.

In a similar manner, gestures performed above the interactive surface, as opposed to on the interactive surface, also may be detected. The term “hover” may be used herein to describe such gestures performed above, but not in contact, with the interactive surface that can be detected and captured, allowing a response to a hover event to be displayed on the display panel. Using the above-described methods, even z-axis motion may be detected with the use of a sufficiently fast image sensor and variable diffuser. Additionally, a hand or other object hovering at height above interactive surface may be tracked, so as to maintain a state of a touch event (or non-touch state) due to a finger/digit associated with that hand. This may enables tracking of a distinction of one hand from another, and even potentially one user from another, so that the interactive display device may maintain a given mode of operation based on whether or not a touch event is associated with the same hand which provided a previous touch event.

For the case of image capture device being within the panel such as in an SIP arrangement, or ‘in-cell’ panel device, defocus of images of objects significantly above the interactive surface may increase significantly with distance from the interactive surface. While the range over which a given level of resolvability may be increased by use of an angularly selective filter, (e.g. an interference based filter), such imaging panels may not image well beyond a few mm above the surface. Thus, to enable hover detection with such systems, an additional vision system may be used to image through the panel, in a similar fashion as described in the LCD scenario. The vision system may include, but is not limited to, components such as an imaging wedge, a rear camera and lens, a folded imaging system, and/or Fresnel-based offset imaging optics.

In such case, the through-panel imaging system may he used to achieve images beyond the interactive surface, while the SIP sensor array may be used to detect touch or image objects at the interactive surface. Since a SIP sensor may be equipped with sensors capable of sensing visible light as well as IR light, the SIP panel may be used to detect touch in some scenarios while capturing objects at interactive surface more appropriate with other wavelengths of light. While the SIP panel may be equipped with multiple arrays of sensors each having different wavelength response in order to capture color information across the spatial domain, it may be that such panel may be only equipped with visible and IR sensor arrays, in one embodiment. However as an example system, in such embodiment, it is further possible to capture a color image of both objects at the surface as well as above the surface by using a combination of image information from both image capture sub-systems. For example, contrast of an object from SIP sensor array may indicate the object is at the surface, and a through-panel imaging system may be used to achieve an image of the same object in color using a color imaging camera, for example, by imaging through an LCD panel while the panel is driven ‘white’. in such case, SIP is used to detect proximity of objects and touch events to interactive surface while through-panel imaging sub-system is used to capture more resolved images, and even color images, of both objects at surface as well as objects above surface, or gestures and hover.

FIG. 3 shows a timing diagram 300 depicting more detailed, non-limiting example implementation of method 200. A first display image frame cycle is shown at 302, and a second display image frame cycle is shown at 304. The timing diagram 300 shows relative changes of state of an infrared light that provides light to a front lighting touch detection system, a display panel, a camera, and a variable diffuser. It will be understood that, in embodiments that utilize a LCD panel, a visible light may be modulated in a similar pattern to that of the display panel to provide backlighting for the display panel.

First referring to the first frame cycle 302, the infrared light and camera are in “off” states for a first portion 306 of the first frame cycle 302, while the display is in an “on” state and the variable diffuser is in a more diffuse state. Thus, the first portion 306 of the first frame cycle 302 displays an image. Next, in a second portion 308 of the first frame cycle 302, the infrared light is in an “on” state, the display panel is in an “off” state, the camera is in an “on” state (i.e. is integrating an image), and the diffuser is in a less diffuse state. Thus, the second portion 308 of the first frame cycle 302 may be used to acquire a less diffuse image of any objects touching or close to the interactive surface.

Next referring to the second frame cycle 304, the infrared light and camera are in “off” states for a first portion 310 of the second frame cycle 304, while the display is in an “on” state and the variable diffuser is in a more diffuse state. Thus, the first portion 310 of the second frame cycle 304 displays an image. Next, in a second portion 312. of the second frame cycle 304, the infrared light is in an “on” state, the display panel is in an “off” state, the camera is in an “on” state, and the diffuser is in a more diffuse state. Thus, the second portion 312 of the second frame cycle may be used to acquire a more diffuse image of any object touching or close to the interactive surface. Then, the images acquired during the first frame cycle and second frame cycle may be compared to determine whether an object is touching the interactive display surface. Further, as noted above, by comparing the gradients between pixels in the two acquired images, a distance of an object above the surface may be determined. It will be understood that, in some embodiments, depending on frequency response of the variable diffuser and the frame rate of the camera, the more diffuse image may be acquired during the time that the display is on, if a wavelength selective optical filter is utilized to filter out display light content into the imaging system, and the infrared light source is turned on for that time of exposure. It will further be noted that, in some embodiments, touch may he detected from only one of the two images, and/or an image may be acquired during only one of the three states illustrated in FIG. 3.

The first portion and second portion of each frame cycle of FIG. 3 may have any suitable duration. In one non-limiting example embodiment, the first portion of each frame cycle may comprise 80% of each frame cycle, and the second portion of each frame cycle may comprise 20% of each frame cycle. This may lead to an image of satisfactory brightness, yet provide ample time to integrate images of a desired quality when the display screen is in an “off” state.

As mentioned above, in some embodiments, an IR image may he captured at the same time that the display is displaying an image and the backlight is turned on, by making use of wavelength selective filters, such as an IR transmissive and visibly opaque filter. As a more specific example, in one embodiment, an interactive display device may in a first state in which the display panel is in an ON state and the variable diffuser is in the more diffuse state, and then operate in a second state in which the display panel is in an ON state and the variable diffuser is in the less diffuse state. Moreover, the interactive display device may acquire a first image while operating in the second state, and acquire a second image while operating in the first state. The infrared-transmissive filter may help prevent visible light from the display that is reflected by the object from reaching the image sensor. Then, either or both of the first and second images may be used to detect touch, hover, etc., as described herein. Further, a single image may be used to detect touch in some embodiments.

In some embodiments, it may be desired to account for the ambient lighting environment surrounding the interactive display device. Therefore, in such embodiments, the camera may be exposed for a time during which the infrared lights are in an “off” state. This may be performed while the display panel is in an “on” state, with the use of a wavelength selective filter to filter out display content light. Likewise, an occasional cycle in which the display panel and infrared lights are both in the “off” state may be used for ambient detection. It will be understood that, once an ambient light level has been determined, the operation of the interactive display device may be adjusted in any suitable manner to compensate for ambient light conditions.

The ambient correction mechanism employed may depend upon the manner of operation of a particular device. For example, in some embodiments, an interactive display device may capture the first image with the variable diffuser is more diffuse state and while the display is in an “on state” by using an infrared filter to filter out the display light from the image. In this case, only two states are utilized in the operational sequence in order to capture the two diffuser states, since the first image is captured at the same time that the display is on, and the second image is captured when display is off and in the less diffuse state. To compensate for ambient in this scenario, additional images may be captured with IR lights off in one or both diffuser states.

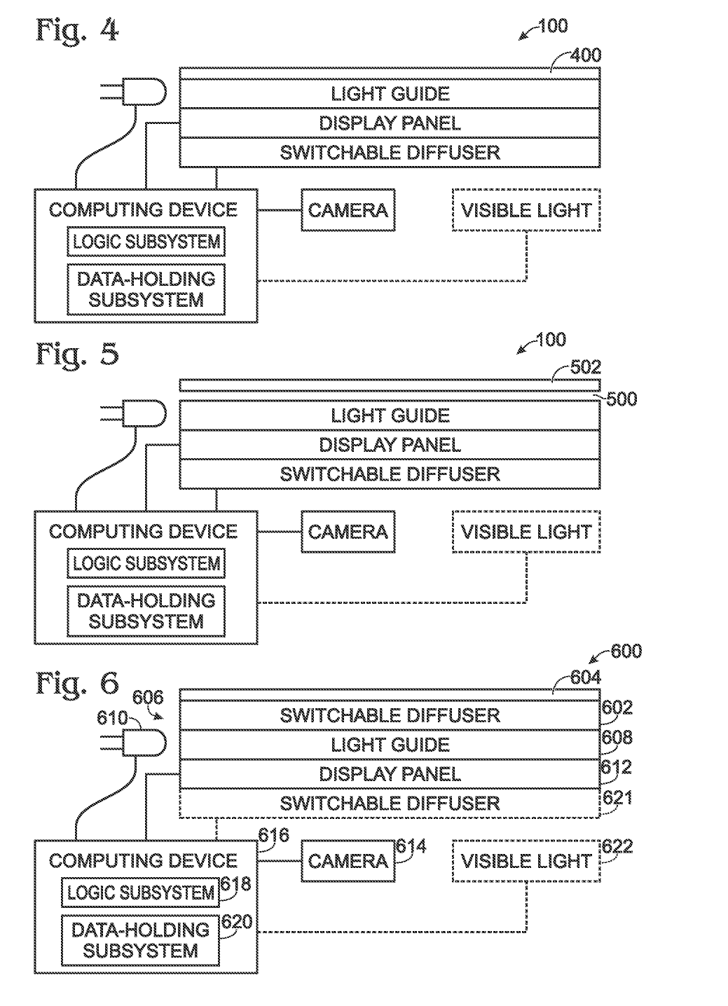

It will be noted that ambient light may appear differently within an image depending on whether the diffuser is in less diffuse or more diffuse state. In such case, ambient may be compensated by capturing images with IR lights off within the timeframe of each of the two states. Further, it will be understood that timing windows for each state are not required to fully fill the timing window allotted by sequence. For example, in some cases, camera integration time may be delayed to begin shortly after the beginning of the integration window in order to allow time for the variable diffuser to fully change state. Allowance for such effects as rise and fall time may serve to improve the distinction of each captured state.

Where the light guide of the front light touch detection system is configured to leak out light even in the absence of a touch, touch may be detected without FTIR events. Thus, in some embodiments, touch may be detected purely from infrared light leaked from the front lighting system, rather than from FTIR events. In such embodiments, FTIR events may be avoided by placing a protective layer, such as a thin sheet of glass, over the front-light. FIG. 4 illustrates such a protective layer 400 added to the interactive display device 100 of FIG. 1. The user of such a protective layer may help to greatly reduce the effect of fingerprint oil, smudges, poor cleaning, and other such factors on the system. The use of a thin protective layer, as opposed to a thicker layer, may help to preserve sharpness of the more diffuse state images acquired by the camera, and also may help to avoid introducing undesirable levels of parallax between touch and display. Examples of suitable materials for the formation of such a protective layer include, but are not limited to treated or hardened glass, such as Gorilla Glass, available from the Corning Inc. of Corning, N.Y.

Further, in some embodiments, a material with a low index of refraction, such as a gap filled with air, may be located optically between the protective layer and the light guide. FIG. 5 illustrates a low index gap 500 located between a protective layer 502 and the other optical components of the embodiment of FIG. 1. The term “low index gap” as used herein describes a space between sa protective layer and a light guide that is filled with a material, such as air, having a lower index of refraction than the light guide material. Note that for the case of air providing the low index gap, the bottom side of the protective layer may have a slightly roughened or slightly bumpy surface so as to mechanically maintain the gap. This surface may further be an engineered surface having proscribed protrusions disposed across the surface, such as microdots, or microspacers, in order to maintain the low index gap while minimizing or limiting impact of scatter effects on both display and off-surface imaging quality.

In the embodiments of FIGS. 1-5, the variable diffuser is located behind the display panel relative to the position of a viewer, and is placed optically between the display panel and touch detection optics. In other embodiments, a variable diffuser may be located on a same side of the display panel as a viewer. FIG. 6 shows an embodiment of such an interactive display system 600. The interactive display system 600 comprises a variable diffuser 602 covered by a protective layer 604 formed from a thin glass or other material. The protective layer 604 may be laminated to the variable diffuser 602, or joined to the interactive display system 600 in any other suitable manner.

The interactive display system 600 further comprises a front light system 606 comprising a light guide 608 disposed on one side of the display panel, and an illuminant 610, such as an infrared light source or light source, configured to introduce infrared light into the light guide 608. A display panel 612 is positioned beneath the light guide 608 (with reference to the orientation of the device shown in FIG. 6), and an image capture device, such as a camera 614, is disposed on an opposite side of the display panel as the light guide so that it may capture an image of objects touching the protective layer via light scattered by the object through the display panel 612. The interactive display system 600 further comprises a computing device 616 having a logic subsystem 618 and a data-holding, subsystem 620 and being in electrical communication with the display panel 612, the variable diffuser 602, the camera 614, and the illuminant 610, as described above with respect to the embodiment of FIG. 1.

Positioning a variable diffuser 602 on an opposite side of the light guide 608 may help to correct for directional effects in vision-based touch detection arising from the use of the light guide 608. As light leaks out of the light guide 608, the path of the leaked light may have a fairly large angle relative to the light guide surface normal. As a result, there may be some shadowing of the light caused by objects on the display, which may affect the detection of the location and the shape of the object. Further, a three-dimensional object placed at a first location on or near interactive surface is illuminated by light near that location for portions of the object close to surface, while portions of that object further away from that surface are illuminated by light emanating from a different location between that location and where illuminant 610 is coupled into the light guide. The use of variable diffuser 602 may help to reduce such directional effects, as the diffusion of leaked light causes the light from the light guide 608 to reach the interactive surface in a in a more even distribution of directions. Likewise, during image display as opposed to image acquisition, the variable diffuser 602 may be switched to a less diffuse state to allow a user to clearly view the display panel 612.

In some embodiments, a second variable diffuser 621 may be disposed optically between the display panel 612 and the camera 614. The second variable diffuser may be used to block a user's view of the camera 614 and other interior components of the interactive display system 600 during display of an image, as described above with regard to the embodiment of FIG. 1. Further, the second variable diffuser 621 may be used in conjunction with a visible light source 622 to provide backlighting for the display panel 612, where the display panel 612 is an LCD panel, also as described above.

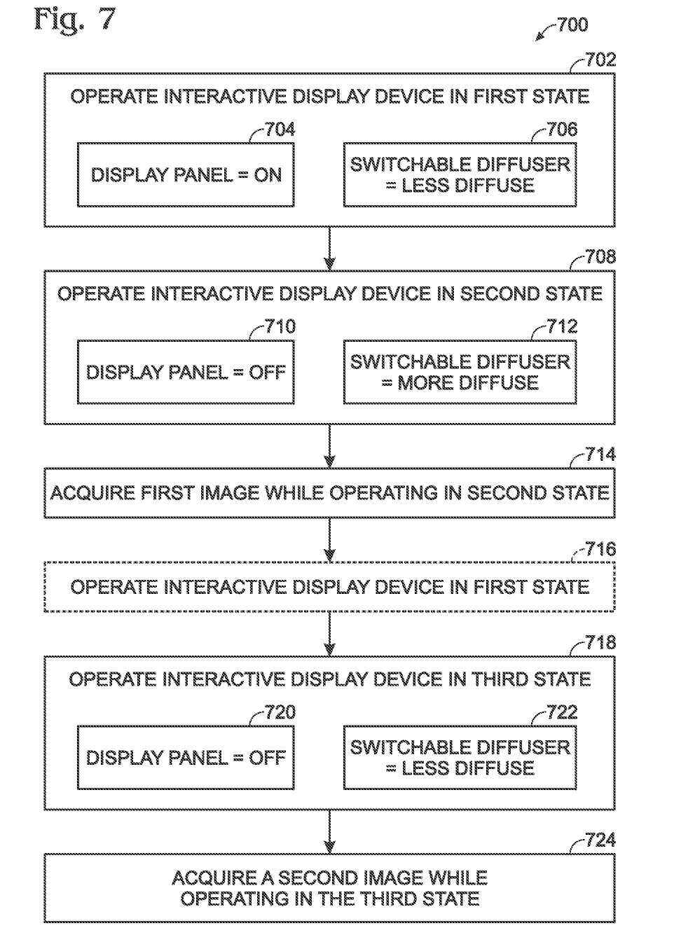

FIG. 7 illustrates an embodiment of a method 700 of operating an interactive display device having a variable diffuser disposed on an opposite side of a light guide as a display panel. Method 700 comprises, at 702, operating the interactive display device in a first state in which the display panel is on (“on” indicates that the display panel is displaying an image), as indicated at 704, and the variable diffuser is in a less diffuse state, as indicated at 706. In this state, the display panel may be viewed through the variable diffuser. During this state, the camera and illuminant each may be in an “off” state.

Next, method 700 comprises, at 708, operating the interactive display device in a second state in which the display panel is off (“off” indicates that the display panel is not displaying an image), as indicated at 710, and the variable diffuser is in a more diffuse state, as indicated at 712. During this state, the optical touch detection front light system is in an “on” state. In this state, the Variable diffuser diffuses light from the front light system, thereby reducing directional effects when this light is scattered from an object and facilitating the detection of the location and shape of object touching or proximate to the interactive surface. While operating the interactive display device in the second state, method 700 further comprises, at 714, acquiring a first image with the image capture device. To facilitate the image acquisition, the illuminant may be in an “on” state while acquiring the image.

Continuing, method 700 may optionally comprise, at 716, again operating the interactive display device in the first state before operating the interactive display device in a third state at 718, or may proceed directly to the third state without operating again in the first state. In the third state, the display panel is off, as indicated at 720, and the variable diffuser is in a less diffuse state, as indicated at 722. Method 700 further comprises, while operating the interactive display device in the third state, acquiring a second image with the image capture device, as indicated at 724. The first and second images may then be used to distinguish objects touching or closer to the interactive surface of the interactive display device from objects located farther away from the interactive surface, as described above. It will be understood that, in embodiments in which it is not desired to detect objects located above the interactive surface, method 700 may repeat processes 702-714 without performing processes 716-724, as it may be sufficient to acquire “more diffuse” images, without acquiring “less diffuse” images, to detect touch.

In embodiments that detect touch via FTIR events, touch light is coupled out from the light guide when pressure is applied to the interactive surface, thereby bringing the variable diffuser and the light guide into optical contact. Light is scattered by the variable diffuser, and at least some of that light is scattered back through the flat panel display towards the camera. It will be understood that the variable diffuser may have upon it a partial or wavelength selective mirror coating, that is, a coating that preferentially reflects the scattered light from the light-guide back towards the camera.

In embodiments that utilize a “leaky” light guide and that thus do not utilize FTIR to detect touch, because light is scattered from the object touching the interactive surface, such a coating may be omitted. The use of a “leaky” light guide may offer the advantage that a touch input may be detected without touch pressure, such that the user experience is similar to that of a capacitive touch detection mechanism. In such embodiments, the display panel, light guide, and variable diffuser may be laminated together using a low index adhesive. In some non-limiting example embodiments, the adhesive bonding the light guide to the display may have a different, lower refractive index compared to the adhesive bonding the light-guide to the variable diffuser.

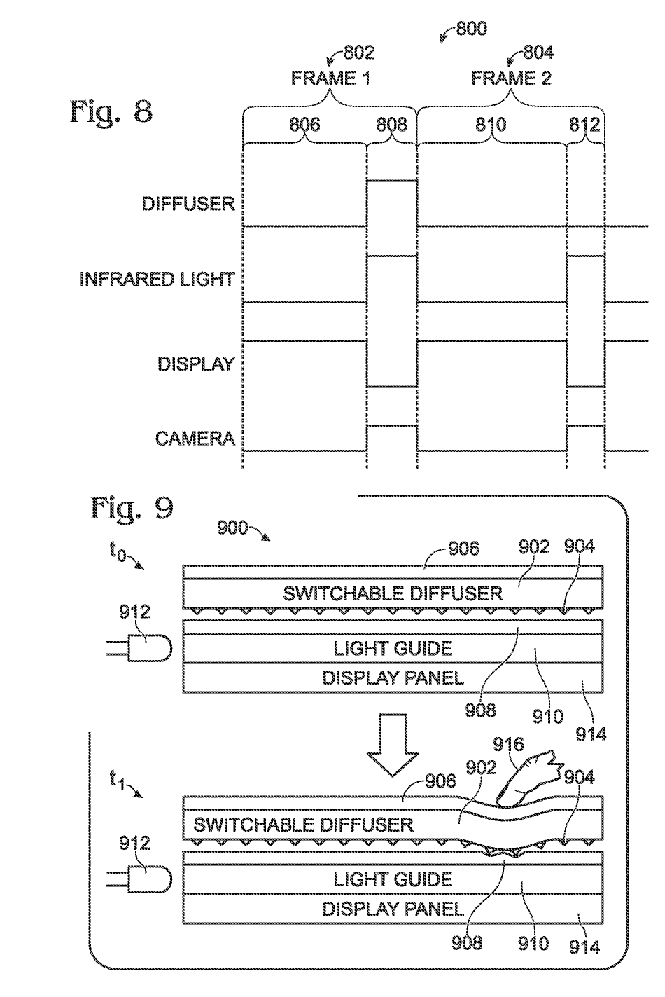

FIG. 8 shows a timing diagram 800 depicting a more detailed, non-limiting example implementation of method 700. A first display image frame cycle is shown at 802, and a second display image frame cycle is shown at 804. The timing diagram 800 shows relative changes of state of an infrared light that provides light to a front lighting touch detection system, a display panel, a camera, and a first variable diffuser, it will be understood that, in embodiments that utilize a LCD panel, a visible light and a second variable diffuser may be modulated in a similar pattern to that of the display panel.

First referring to the first frame cycle 802, the infrared light and camera are in “off” states for a first portion 806 of the first frame cycle 802, while the display is in an “on” state and the variable diffuser is in a less diffuse state. Thus, the first portion 806 of the first frame cycle 802 displays an image. Next, in a second portion 808 of the first frame cycle 802, the infrared light is in an “on” state, the display panel is in an “off” state, the camera is in an “on” state (i.e. is integrating an image), and the diffuser is in a more diffuse state. Thus, the second portion 808 of the first frame cycle 802 may be used to acquire a more diffuse image of any objects touching or close to the interactive surface.

Next referring to the second frame cycle 804, the infrared light and camera are in “off” states for a first portion 810 of the second frame cycle 804, while the display is in an “on” state and the variable diffuser is in a less diffuse state. Thus, the first portion 810 of the second frame cycle 804 displays an image. Next, in a second portion 812 of the second frame cycle 804, the infrared light is in an “on” state, the display panel is in an “off” state, the camera is in an “on” state, and the diffuser is in a less diffuse state. Thus, the second portion 812 of the second frame cycle 804 may be used to acquire a less diffuse image of any object touching or close to the interactive surface.

Then, the images acquired during the first frame cycle and second frame cycle may be compared to determine whether an object is touching, the interactive display surface. Further, as mentioned above, by comparing the gradients between pixels in the two acquired images, a distance of an object above the surface may be determined. It will be understood that, in some embodiments in which it is only desired to detect actual touch events, rather than objects spaced from the interactive surface, the Frame 2 process may be omitted.

The first portion and second portion of each frame cycle of FIG. 8 may have any suitable duration. In one non-limiting example embodiment, the first portion of each frame cycle may comprise 80% of each frame cycle, and the second portion of each frame cycle may comprise 20% of each frame cycle. In this embodiment, the display panel displays an image to a user for 80% of the time. This may lead to an image of satisfactory brightness, yet provide ample time to integrate images of a desired quality when the display screen is in an “off” state.

FIG. 9 shows another embodiment of an arrangement of optical components that comprises a low index gap separating a variable diffuser and a light guide. Optical component arrangement 900 comprises a variable diffuser 902 protective layer 906, and a plurality of protrusions 904 extending; from the variable diffuser into a low index gap between the variable diffuser 902 and a light guide 910. Further, the light guide 910 comprises a deformable layer 908, such as a silicone sheet, forming the other side of the low index gap. An illuminant 912 is configured to introduce light into the light guide 910, and a display panel 914 is located on an opposite side of the light guide 910 as the variable diffuser 902. It will be appreciated that the sizes and scales of the various structures shown in FIG. 9 are exaggerated for the purpose of illustration.

As illustrated at t₀ in FIG. 9, in the absence of a touch input, the deformable layer 908 remains separated from the protrusions 904. However, when an object touches the protective layer 906, the protrusions 904 beneath the touch input are pushed into contact with the deformable layer 908, thereby locally deforming the deformable layer 908.

The use of the protrusions 904 in combination with the deformable layer 908 allows significant local deformation of the deformable layer 908 to be achieved with moderate pressure, and thereby helps to effectively provide mechanical gain in the touch sensing system. The resulting curvature of the surface of the deformable layer 908 may cause light to escape from the deformable layer 908 at a glancing angle to the deformable layer surface. The light that escapes the deformable layer 908 is then diffused by the variable diffuser 902, thereby becoming available for touch detection.

The protrusions 904 may have any suitable configuration. For example, in some embodiments, the protrusions may comprise small bumps or prisms. Likewise, the protrusions 904 may be formed in any suitable manner, including but not limited to via extrusion or embossing.

In some embodiments, a guest-host dye may be added to the variable diffuser material. Such a dye may be used to make the variable diffuser material dark in the more diffuse state, thereby reducing the ambient scattered light without affecting the performance of the system in the IR.

Further, in some embodiments, an infrared reflecting filter may be provided as an outermost layer on the interactive surface. This may allow an infrared optical touch detection system to be “sealed” from the outside, allowing vision to detect touch without interference from other infrared sources, such as interior lighting or solar radiation. It will be understood that such a configuration may be used either in air FTIR architecture, “leaky light guide” architecture, or in any other suitable architecture.

It will be understood that the image sensor in the above-described embodiments, whether a camera or a SIP arrangement, may be a depth sensor (or “3D camera”), such as a stereo camera or structured light depth camera. Such a 3D camera, when used in conjunction with a variable diffuser, may be able to sense 3D gestures above the screen and detect touch events with potentially high accuracy. Any suitable optics may be used in such a 3D image sensor system, including but not limited to an imaging wedge, a reverse RPTV imaging system, and a reversed Fresnel-based folded imaging system. Further, some embodiments may employ two image capture devices. As a more specific example, one embodiment utilizes using a SIP sensor array to capture images of objects in close proximity to interactive surface, and a 3D sensor to capture three-dimensional content above the interactive surface. As some 3D sensors may have a minimum operational distance, such systems as an imaging wedge, among others, may increase an optical path length to enable a buffer distance so as to allow 3D information to start just beyond the interactive surface, and detect 3D information within a FOV (Field of View) and within a distance range up to a maximum distance limit, in such an embodiment, a variable diffuser placed below the display panel may be used to hide internal structures of the interactive display system by operating in the more diffuse state with the backlight ON, and may switch to a less diffuse state with display off in order to capture images beyond/above the interactive surface. Touch may be detected by the sensor array within the SIP panel, with IR light being provided by a front light guide, backlighting (e.g. from a source behind the display panel), or in any other suitable manner. Similarly, a two-sensor image sensing system may also be used with a 2D wedge-based imaging system used in conjunction with a SIP sensor array.

Where the 3D camera is a stereo camera, it will be understood that touch and hover may be detected and distinguished in various different ways. For example, in some embodiments, images may be acquired by the “left” camera and the “right” camera of the stereo camera with the variable diffuser at different diffusivities to acquire touch and/or hover data as described above. Likewise, both cameras of the stereo camera may be used to acquire image data at a same diffusivity, and the stereo data from the stereo camera may be used to determine touch and/or hover from the z-axis component of the stereo data. In this embodiment, the more diffuse state could be utilized to detect touch while the less diffuse state could be used to detect hover via the stereo data. Further, in yet other embodiments, stereo images may be acquired at a same diffusivity, and then the stereo data is used to disambiguate other depth measurements made as described above to achieve a more robust hover determination. It will be understood that these embodiments are described for the purpose of example, and are not intended to be limiting in any manner.

It is to be understood that the configurations and/or approaches described herein are presented for the purpose of example, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. An interactive display device, comprising:
a display panel configured to display an image on an interactive surface;
an image capture device configured to capture an image of the interactive surface; a switchable diffuser disposed optically between the display panel and the image capture device, the switchable diffuser being switchable between two or more states comprising a less diffusive state and a more diffusive state;
a logic subsystem comprising one or more logic devices; and
memory comprising instructions executable by the logic subsystem to operate the display panel, the image capture device, and the variable diffuser.

2. The interactive display device of claim 1, wherein the display panel comprises an emissive display panel.

3. The interactive display device of claim 1, wherein the display panel comprises a light-modulating display panel.

4. The interactive display device of claim 3, further comprising a visible light source configured to illuminate the variable diffuser as a display panel backlight.

5. The interactive display device of claim 1, wherein the instructions are executable to:
operate the interactive display device in a first state in which the display panel is in an ON state and the variable diffuser is in the more diffuse state;
operate the interactive display device in a second state in which the display panel is in an OFF state and the variable diffuser is in the less diffuse state;
acquire a first image while operating in the second state;
operate the interactive display device in a third state in which the display panel is in an OFF state and the variable diffuser in the more diffuse state; and
acquire a second image while operating in the third state.

6. The interactive display device of claim 5, wherein the instructions are executable to operate the interactive display device sequentially in the first state, in the second state, in the first state, and in the third state.

7. The interactive display device of claim 5, wherein the instructions are executable to detect a touch event by comparing the first image and second image, and to display a response to the touch event on the display panel.

8. The interactive display device of claim 5, wherein the instructions are executable to detect a hover event by comparing the first image and the second image, and to display a response to the hover event on the display panel.

9. The interactive display device of claim 5, further comprising an infrared illuminant configured to illuminate the interactive surface with infrared light, and wherein the instructions are executable to operate the infrared illuminant in an OFF state during the first state, and to operate the illuminant in an ON state during the second state and the third state.

10. The interactive display device of claim 5, wherein the variable diffuser is a first variable diffuser, and further comprising a second variable diffuser located on an opposite side of the display panel as the first variable diffuser.

11. The interactive display device of claim 10, wherein the instructions are executable to:
in the first state, operate the second variable diffuser in a less diffuse state;
in one or more of the second state and the third state, operate the second variable diffuser in a more diffuse state.

12. The interactive display device of claim 1, further comprising a front light system comprising a light guide, and a protective layer disposed on an opposite side of the light guide as the display panel.

13. The interactive display device of claim 12, further comprising a low index gap disposed optically between the protective layer and the front light system.

14. The interactive display device of claim 1, further comprising an infrared filter disposed optically between the display panel and the image capture device, wherein the variable diffuser is located optically on an opposite side of the display panel as the interactive surface, and wherein the instructions are executable to:
operate the interactive display device in a first state in which the display panel is in an ON state and the variable diffuser is in the more diffuse state;
operate the interactive display device in a second state in which the display panel is in an ON state and the variable diffuser is in the less diffuse state;
acquire a first image while operating in the second state; and
acquire a second image while operating in the first state.

15. An interactive display device, comprising:
a sensor-in-pixel display panel configured to display an image on an interactive surface, the sensor-in-pixel display panel comprising a first image sensor;
a second image sensor disposed on an opposite side of the display panel as the interactive surface and being configured to capture an image of objects through the display panel;
a variable diffuser disposed optically between the display panel and the second image sensor, the variable diffuser being switchable between two or more states comprising a less diffusive state and a more diffusive state;
a logic subsystem comprising one or more logic devices; and
memory comprising instructions executable by the logic subsystem to operate the display panel, the first image capture device, the second image capture device, and the variable diffuser.

16. The interactive display device of claim 15, wherein the instructions are executable to:
operate the interactive display device in a first state in which the display panel is in an ON state and the variable diffuser is in the more diffuse state;
acquire a first image with the first image sensor;
operate the interactive display device in a second state in which the variable diffuser in the less diffuse state; and
acquire a second image with the second image sensor while operating in the second state.

17. The interactive display device of claim 15, wherein the variable diffuser is a first variable diffuser, and further comprising a second variable diffuser located optically between the display panel and the interactive surface.

18. The interactive display device of claim 15, wherein the second image sensor comprises a depth sensor.

19. An interactive display device, comprising:
a display panel configured to display an image;
a front light system comprising a light guide disposed on one side of the display panel and an illuminant configured to introduce infrared light into the light guide;
a protective layer disposed on an opposite side of the light guide as the display panel and being separated from the light guide by a low index gap;
an image capture device disposed on an opposite side of the display panel as the light guide and being configured to capture an image of objects through the display panel and the light guide;
a variable diffuser disposed at a location optically between the protective layer and the image capture device, the variable diffuser being switchable between two or more states comprising a less diffusive state and a more diffusive state;
a logic subsystem comprising one or more logic devices; and
memory comprising instructions executable by the logic subsystem to operate the display panel, the front light system, the image capture device, and the variable diffuser.

20. The interactive display device of claim 19, wherein the variable diffuser is located optically between the image capture device and the display panel.
